(19) United States
(12) Patent Application Publication
(10) Pub. No.: US 2024/0370353 A1
(43) Pub. Date: Nov. 7, 2024

(54) SYSTEM, METHOD, AND MEDIUM FOR LIFECYCLE MANAGEMENT TESTING OF CONTAINERIZED APPLICATIONS

(71) Applicant: Rakuten Mobile, Inc., Tokyo (JP)

(72) Inventor: Subhankar DAS, Tokyo (JP)

(21) Appl. No.: 18/248,690

(22) PCT Filed: Oct. 28, 2022
(86) PCT No.: PCT/JP2022/040552

§ 371 Date: Apr. 12, 2023

(51) Int. Cl. G06F 11/36

(52) U.S. Cl. CPC G06F 11/3664; G06F 11/3688

(57) ABSTRACT

Lifecycle Management Testing of a containerized application is conducted by executing a test script by a first containerized application thereby causing an Application Programming Interface (API) call to be issued to at least one automated testing system, running, by the at least one automated testing system, a testing sequence on a second containerized application, different from the first containerized application, based on the API call, and automatically displaying testing sequence results, where the results include an assessment of the health of the second containerized application.

### RELATED APPLICATIONS

The present application is a National Phase of International Application No. PCT/JP2022/040552, filed Oct. 28, 2022.

### BACKGROUND

Life Cycle Management (LCM) is performed to check the behavior and functionality, among other parameters, of containerized application pods. A containerized application is an application that runs in an isolated runtime environment called a container. The container encapsulates all the dependencies of its application, including binaries, system libraries, configuration files, and the like. Containers are portable, that is, they run consistently across multiple hosts. A pod is a collection of one or more containers encapsulating applications. LCM testing helps to determine how a pod will behave in a production environment, that is, how the pod will behave when made accessible to end-users. Testing a pod prior to deployment helps, for example, improve the health of a pod (e.g., reliability and performance) so that the pod behaves as predicted when moved to a production environment. LCM testing is used to check, for example, level of application availability, response to an infrastructure event, distribution of microservices across multiple servers, communication between microservices, resilience of applications after a network interruption, and to make sure applications continue to run after an instance or pod reboot, an application component crash, or central processing unit (CPU) starvation of an instance or a pod.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of an exemplary system suitable for LCM testing in accordance with some embodiments.

FIG. 2 is a flowchart of an exemplary method suitable for LCM testing in accordance with some embodiments.

FIG. 3 is a block diagram of an electronic device suitable for LCM testing in accordance with some embodiments.

FIG. 4 is a sample LCM test report generated by method 200 according to some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the connection of a first feature to a second feature in the description that follows may include embodiments in which the first and second features are directly connected, and may also include embodiments in which additional features may be connected and/or arranged between the first and second features, such that the first and second features may not be in direct connection or contact. In addition, the present disclosure may repeat reference numerals and/or letters in the various examples. This repetition is for the purpose of simplicity and clarity and does not in itself dictate a relationship between the various embodiments and/or configurations discussed.

A pod is the smallest execution unit of a containerized application system. If a pod or the node a pod is running on fails, a new replica of the pod can be created and launched in order to keep that pod's one or more applications up and running. A node is a machine that runs the pod housing the containerized applications and can be a physical or virtual machine. Containers differ from virtual machines because containers do not include their own operating systems.

When not running, a container exists as a container image, which is a packaged save file containing the application source code, binaries, and other files that exist within the container and allow it to function when the container is running. A container image can instantiate any number of container iterations needed to provide the desired functionality. The containers can be deployed to a cloud network in order to provide application services to network users.

In order to run containerized applications at scale, for example, on networks that may have thousands or millions of users, an orchestration (i.e., container management) platform is generally used in order to manage the deploying and scaling of the containerized applications. Kubernetes is an example of one such containerized management/orchestration platform.

Before a pod can move from the development stage to the production stage, LCM testing is conducted to test the behavior of the pod under different operating conditions. The lifecycle of a pod includes, but is not limited to: initialization of the pod, a pending state when the pod is ready to run and on standby, a create container state when the pod creates containers, a running state, where the pod is up and running, and an error state, which is entered upon the output of an error associated with the pod, for example, when one of the containers fails to run. The type of error output depends on the particular malfunction of the pod. LCM testing of pods and their containerized applications allows for the gathering of data related to the performance of the pods and applications under production conditions, that is, when the pods and applications are deployed to be accessible to the intended users of the applications.

In some approaches, testing is conducted through user interfaces such as a command line interface (CLI) and/or a graphical user interface (GUI). Depending on the scale of the deployment, using graphical user interfaces (GUIs) and command line interfaces (CLIs) may add significantly to LCM testing and deployment time. This contributes to application release delays. Further, attempts at avoiding application release delays by rushing application deployment contributes to the release of unreliable applications that may frustrate users.

In contrast, an LCM testing regime that relies less on GUIs and CLIs can help increase the efficiency, speed, and reliability of LCM testing and contribute to shorter testing and deployment schedules, while also maintaining quality and reliability over GUI and CLI-dependent LCM testing.

LCM testing helps determine the health of a pod prior to deployment. Pods have both a specification and a status. The specification indicates where the pod is in its lifecycle and the status indicates the specific status of a pod. LCM testing involves the analysis of certain parameters associated with a pod. Specifically, LCM testing of a pod can include verification of pod parameters such as liveliness, readiness, affinity and anti-affinity, size of container images, highly available (HA)/node failover, replicas, multi-node, and Horizontal Pod Autoscaling (HPA).

A liveliness probe indicates the health of a pod, that is whether the pod is running. If a pod is unhealthy (e.g., fails to run), the pod can be restarted. For example, if the liveliness probe returns a “success” result, then the pod is determined to be healthy (i.e., running). If the liveliness probe returns a “failure” result, the pod is unhealthy according to the liveliness probe. A liveliness probe may be configured with a timer which triggers periodic liveliness checking of a pod. A readiness probe indicates whether a pod is ready to handle (e.g., respond to) a request. A “success” result indicates that the pod is ready to handle a request. A “failure” result indicates that a pod is not ready to handle a request. The readiness probe helps determine whether traffic to a pod should sent or not, based on whether the pod is ready to receive traffic. Affinity and Antiaffinity defines the conditions or placement of the scheduling of a pod. Scheduling refers to the assignment of a pod to a node. Pods can be grouped together based on affinity. For example if two or more pods have affinity for one another, they can be scheduled on the same node. However, if two or more pods should not be scheduled on the same node, this is referred to as antiaffinity. Determining affinity and antiaffinity of pods allows for pods to be effectively spread across multiple nodes, which provides enhanced availability in the case of node failure. Container image size refers to the data size of a container image. Smaller images can be downloaded more quickly than larger images. In general, images should be smaller than 25 megabytes (MB), however, image sizes up to 50 MB are acceptable. If an image is greater than 100 MB, the image will be flagged. Image size is not a required parameter in LCM testing and does not decide whether the LCM test returns a pass or fail result. High availability (HA)/node failover testing is associated with redundancy, which can provide both high availability and load balancing features. For example, multiple pods having the same roles that are spread across multiple nodes provide high availability in the case of node failure because traffic can be shifted from one pod to another pod on a different node without significant interruption in service. The Horizontal Pod Autoscaler (HPA) helps automatically scale the number of pods based on metrics such as CPU utilization or other appropriate metric. For example, the number of pods on a node may be reduced if CPU and or memory utilization is at or above a predetermined threshold. Minimum thresholds may also be set for memory and CPU utilization. The HPA is not a required parameter in LCM testing and does not decide whether the LCM test returns a pass or fail result.

In some embodiments of the present disclosure, a test script is executed by a first containerized application, thereby causing an Application Programming Interface (API) call to be issued to at least one automated testing system, at least one automated testing system runs a testing sequence on a second containerized application which is different from the first containerized application, based on the issued API call, and testing sequence results associated with the second containerized application are automatically displayed which include an assessment of the health of the second containerized application. In some embodiments, the testing sequence includes testing pod parameters such as liveliness, readiness, affinity and anti-affinity, size of container images, highly available (HA)/node failover, replicas, multi-node, and Horizontal Pod Auto-scaling (HPA). In some embodiments, other components, such as binaries or other appropriate application components are verified. In some embodiments, a representational state transfer (REST) API call is used as the API call. In some embodiments, the at least one automated testing system is an automated test suite such as Jenkins™.

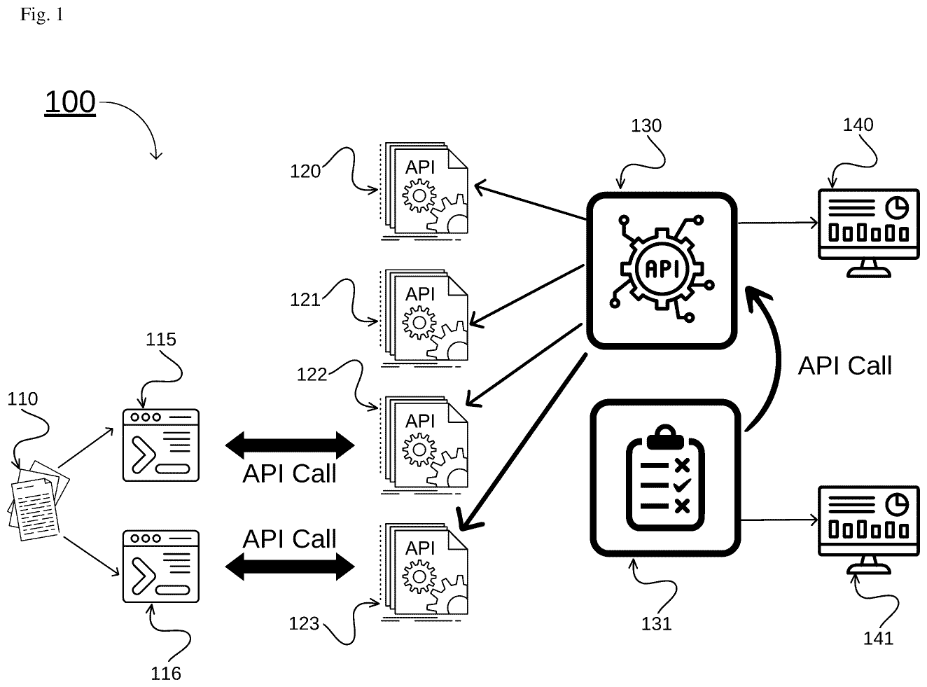

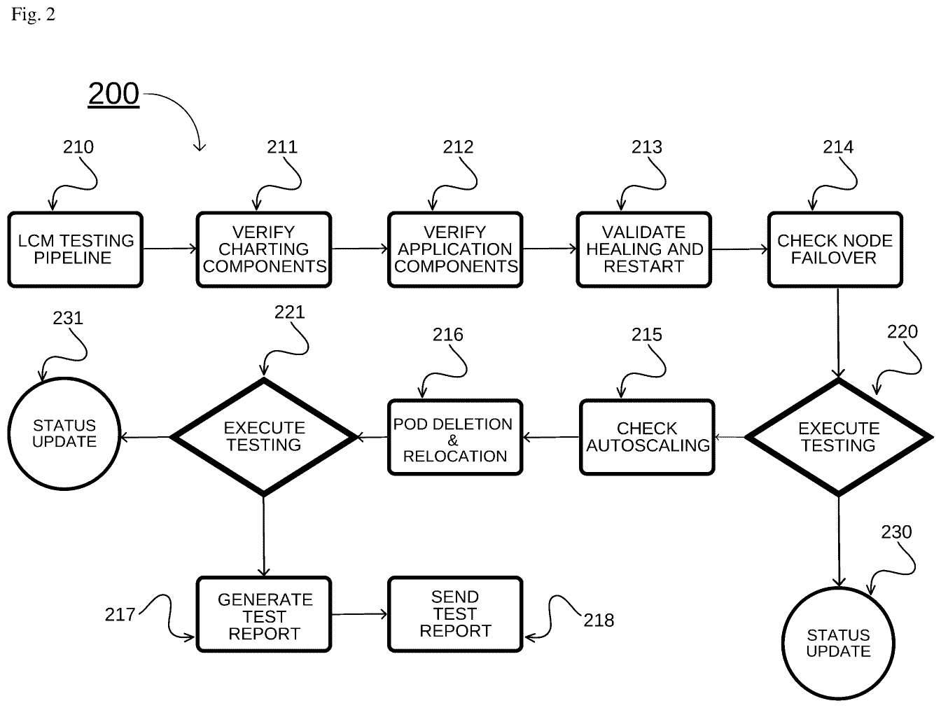

FIG. 1 is a diagram of exemplary system 100 suitable for LCM testing in accordance with some embodiments. A user executes one or more test scripts 110 which will interact with a target cluster to carry out LCM testing of one or more pods. Execution of the one or more test scripts 110 causes a first automated LCM testing application command to be executed via command line 116. In some embodiments, the LCM testing application command is executed via an API call between REST API Agent 130 and the LCM testing pod 131. In some embodiments, the command is a login command for logging in to the LCM testing application. The LCM testing application can be an application that automates the deployment, scaling and lifecycle management of containerized applications such as Robin.io™. Execution of the one or more test scripts 110 causes a REST API call (shown as “API Call” arrows between the command line interfaces 115 and 116 and API gateways 120-123) through an API gateway (any of API gateways 120-123) to execute a containerized software (e.g., kubernetes) command via a command line 115 command (e.g., kubtectl) to check the status of a target pod and/or container. Execution of the one or more test scripts 110 causes a REST API call (shown as “API Call” arrows between the command line interfaces 115 and 116 and API gateways 120-123) to be issued between REST API Agent pod 130 and an artifactory application (e.g., JFrog™) to check the size of a docker image stored by the artifactory application. Execution of the one or more test scripts 110 calls an automation pipeline (e.g., LCM TESTING PIPELINE 210, shown in FIG. 2) of an automated testing application via any of the API gateways 120-123 from the REST API Agent pod 130 via an API call (shown as “API Call” arrow between the API Agent pod 130 and LCM Testing pod 131) to execute a separate automation test script which causes the automated testing application to validate application features of the pod under test while the LCM testing is in progress. The LCM testing pod 131 is deployed on a cluster accessible to any of the clusters where an application to be LCM tested is deployed. Further, the LCM testing pod 131 is configured to communicate with the API Agent pod via REST API calls. Both the LCM testing pod and the API Agent pod report test progress and provide testing sequence results through a report display 140 and/or 141 (e.g., a graphical user interface (GUI)) as well as through the generation of testing sequence report documents (e.g., spreadsheets).

FIG. 2 is a flowchart of exemplary method 200 suitable for LCM testing in accordance with some embodiments. Each operation of method 200 is triggered with an API call (e.g., REST API call or other application-specific API call such as a kubtectl API call). However, the sending of the test report (operation 218) can be triggered with a script. Method 200 is designed to get application information from a pod under test and analyze the information, fetch all objects in a namespace and analyze each fetched object, and to test on a Helm™ application release (e.g., decode helm release information that is stored as kubernetes secrets in a particular version of Helm and analyze the objects in the decoded secret). In operation 210 an LCM testing pipeline is initiated for causing an automated testing application to carry out specific testing tasks. In some embodiments, the LCM testing pipeline is generated via a testing script. In some embodiments, the LCM testing pipeline is downloaded from a stored library. The LCM testing pipeline includes steps of: cleaning the workspace of the testing application, parsing application data to be used in the creation of an LCM configuration file, cloning LCM automation code (e.g., checking out an LCM testing automation script to be used for the automated testing), removing old configuration files (e.g., delete old LCM configuration files), generate new LCM testing configuration file to be used in the testing process, and run the LCM test script. Running the LCM test script executes the LCM automation script, which invokes test cases and provides testing results for a pod under test. Operation 210 also initiates an API call that causes the execution of operation 211. In operation 211, application bundles are verified. This includes verification of readiness probe, liveness probe, affinity and anti-affinity rules, replicas, CPU and memory requirements for running the pod under test, storage configurations, and auto healing bundles. In this application, auto healing refers to a pod's ability to recover from errors or a failure in operation. For example, if a pod begins to malfunction, it may auto heal by restarting to recover form the malfunction. In operation 212 application components are verified, including verification of the bundles mentioned in operation 211 in at least one application namespace. In operation 213 healing and restart time of the pod under test is validated by deleting application replicas, partially deleting pod components to trigger auto healing and checking the time it takes for auto healing, and also measuring pod restart times. In operation 214 node failover operations of a pod under test is checked by replacing and/or restarting nodes and verifying the respawning of the pod or pods under test. Optionally, application functionality is checked during the replacing and/or respawning of a pod or pods under test and/or performance scenarios to check auto scaling of a pod or pods under test can be conducted in operation 214. That is, how well an application hosted by a pod under test functions during pod replacement and/or respawn and spawning of new pods or deletion of unnecessary pods is carried out (i.e., auto scaling). In operation 220 the LCM testing of the pod under test is executed and a “pass” or “fail” result is determined. A “pass” result, for example, is when the pod under test operates normally. A “fail” result, for example, is when the pod fails to operate or partially fails to operate. The pass or fail results are recorded as a status update of the operation of the pod under test in operation 230. In operation 215 autoscaling of the pod under test is checked. That is, how the pod replicates or deletes copies of itself in response to increased or decreased demand for the pods application services. In operation 216 performance of the pod under test is checked in the event of deletion and relocation of the pod (e.g., relocation to a different node). In operation 221 the automated testing suite executes testing of the pod again. In some embodiments, operation 221 executes testing using at least a portion of the output from the test conducted in operation 220. In operation 221, the LCM testing of the pod under test is executed and a “pass” or “fail” result is determined. A “pass” result, for example, is when the pod under test operates normally. A “fail” result, for example, is when the pod fails to operate or partially fails to operate. The pass or fail results are recorded as a status update of the operation of the pod under test in operation 231. In operation 217 test data is consolidated and a test report is generated based on the previous test operations. In operation 218 the test report generated in operation 217 is sent to a predetermined recipient (e.g., email recipient). Operation 218 is optional.

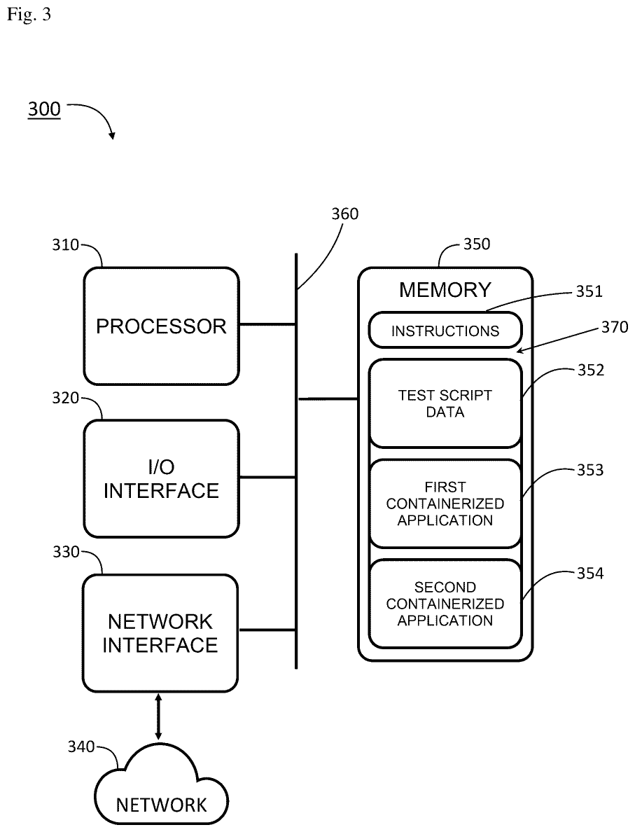

FIG. 3 is a block diagram of a system 300 for implementing a method for connecting to a network, using an Internet-enabled radio node, in accordance with some embodiments. System 300 includes a hardware processor 310 and a non-transitory, computer readable storage medium 350 encoded with, (i.e., storing), the computer program code 370, (i.e., a set of executable instructions). Computer readable storage medium 350 is also encoded with instructions 351 for interfacing with different devices within a network. The processor 310 is electrically coupled to the computer readable storage medium 350 via a bus 360. The processor 310 is also electrically coupled to an I/O interface 320 by bus 360. A network interface 330 is also electrically connected to the processor 310 via bus 360. Network interface 330 is connected to a network 340, so that processor 310 and computer readable storage medium 350 are capable of connecting to external elements via network 340. The processor 310 is configured to execute the computer program code 370 encoded in the computer readable storage medium 350 in order to cause system 300 to be usable for performing a portion or all of the operations as described in method 200.

In some embodiments, the processor 310 is a central processing unit (CPU), a multiprocessor, a distributed processing system, an application specific integrated circuit (ASIC), and/or a suitable processing unit.

In some embodiments, the computer readable storage medium 350 is an electronic, magnetic, optical, electromagnetic, infrared, and/or a semiconductor system (or apparatus or device). For example, the computer readable storage medium 350 includes a semiconductor or solid-state memory, a magnetic tape, a removable computer diskette, a random-access memory (RAM), a read-only memory (ROM), a rigid magnetic disk, and/or an optical disk. In some embodiments using optical disks, the computer readable storage medium 350 includes a compact disk-read only memory (CD-ROM), a compact disk-read/write (CD-R/W), and/or a digital video disc (DVD).

In some embodiments, the storage medium 350 stores the computer program code 370 configured to cause system 300 to perform method 200. In some embodiments, the storage medium 350 also stores information needed for performing a method 200 as well as information generated and/or used during performing the method 200, such as test script data 352, first containerized application 353, and second containerized application 354 and/or a set of executable instructions to perform the operation of method 200.

In some embodiments, the storage medium 350 stores instructions 351 for interfacing with external components within the network. The instructions 351 enable processor 310 to generate instructions readable by the external components to effectively implement method 200.

System 300 includes I/O interface 320. I/O interface 320 is coupled to external circuitry. In some embodiments, I/O interface 320 includes a keyboard, keypad, mouse, trackball, trackpad, and/or cursor direction keys for communicating information and commands to processor 310.

System 300 also includes network interface 330 coupled to the processor 310. Network interface 330 allows system 300 to communicate with network 340, to which one or more other computer systems are connected. Network interface 330 includes wireless network interfaces such as BLUETOOTH, WIFI, WIMAX, GPRS, or WCDMA; or wired network interface such as ETHERNET, USB, or IEEE-1394. In some embodiments, method 200 is implemented in two or more systems 300, and information such as memory type, memory array layout, I/O voltage, and I/O pin location are exchanged between different systems 300 via network 340.

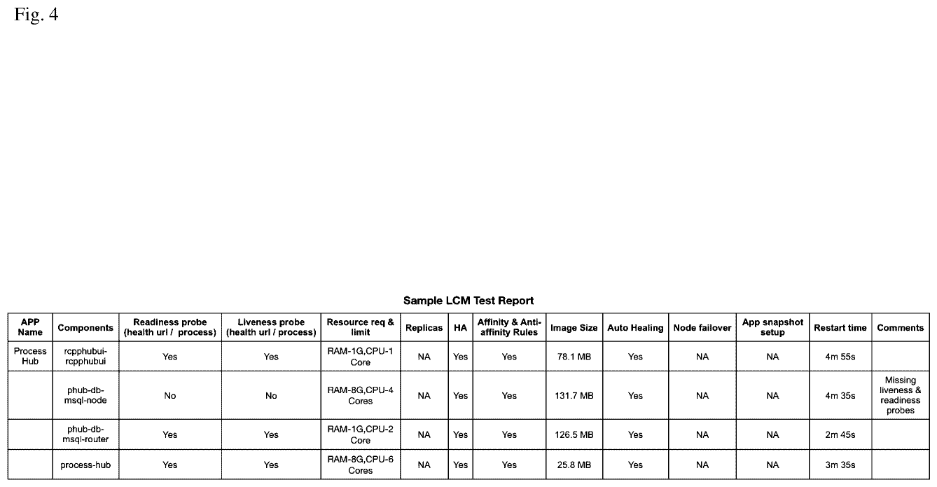

FIG. 4 is a sample LCM test report generated by method 200. The report includes the name of the application in a pod under test (APP Name), which is “Process Hub” in this example. The “Components” column lists the components tested, and other parameters such as readiness, liveness, and the like which are each explained herein, are also shown. The report may be displayed and/or sent to a recipient (e.g., email recipient).

An aspect of this disclosure relates to a system for lifecycle management testing of containerized applications, the system that includes a memory that stores instructions, and at least one processor configured by the instructions to perform operations that include executing a test script by a first containerized application thereby causing an Application Programming Interface (API) call to be issued to at least one automated testing system, running, by the at least one automated testing system, a testing sequence on a second containerized application, different from the first containerized application, based on the API call, and automatically displaying testing sequence results, wherein the results comprise an assessment of the health of the second containerized application. In some embodiments, the first containerized application runs in a separate container from the first containerized application. In some embodiments, the operations further include running, by a second automated testing system, a second test sequence on the second containerized application, using the testing sequence results as an input parameter. In some embodiments, the operations further include running, by a third automated testing system, a third test sequence on the second containerized application, using the testing sequence results as an input parameter. In some embodiments, the first and second containerized applications are in different pods on a same cluster of a network. In some embodiments, the operations further include executing a second testing script, and the execution of the testing script causes the at least one automated testing system to generate a testing pipeline to be used as the testing sequence. In some embodiments, the assessment of the health of the second containerized application includes at least one of: checking whether the application is up and running, checking whether the application is ready to accept traffic, checking node scheduling of the application, checking how many copies of the application should be scheduled, checking a container image size of the application, or checking node failover information associated with the application.

An aspect of this disclosure relates to a computer-implemented method for lifecycle management testing of containerized applications. The method includes executing a test script by a first containerized application thereby causing an Application Programming Interface (API) call to be issued to at least one automated testing system, running, by the at least one automated testing system, a testing sequence on a second containerized application, different from the first containerized application, based on the API call, and automatically displaying testing sequence results, wherein the results comprise an assessment of the health of the second containerized application. In some embodiments, the first containerized application exists in a separate container from the first containerized application. In some embodiments, the method further includes running, by a second automated testing system, a second test sequence on the second containerized application, using the testing sequence results as an input parameter. In some embodiments, the method further includes running, by a third automated testing system, a third test sequence on the second containerized application, using the testing sequence results as an input parameter. In some embodiments, the first and second containerized applications are in different pods on a same cluster of a network. In some embodiments, the method further includes executing a second testing script, wherein the execution of the testing script causes the at least one automated testing system to generate a testing pipeline to be used as the testing sequence. In some embodiments, the assessment of the health of the second containerized application includes at least one of: checking whether the application is up and running, checking whether the application is ready to accept traffic, checking node scheduling of the application, checking how many copies of the application should be scheduled, checking a container image size of the application, or checking node failover information associated with the application.

An aspect of this disclosure relates to a non-transitory computer readable medium for lifecycle management testing of containerized applications, storing instructions that, when executed by at least one processor, cause the at least one processor to perform operations including executing a test script by a first containerized application thereby causing an Application Programming Interface (API) call to be issued to at least one automated testing system, running, by the at least one automated testing system, a testing sequence on a second containerized application, different from the first containerized application, based on the API call, and automatically displaying testing sequence results, wherein the results include an assessment of the health of the second containerized application. In some embodiments, the first containerized application exists in a separate container from the first containerized application. In some embodiments, the method further includes running, by a second automated testing system, a second test sequence on the second containerized application, using data output by the first test sequence. In some embodiments, the first and second containerized applications are in different pods on a same cluster of a network. In some embodiments, the method further comprises executing a second testing script, and the execution of the testing script causes the at least one automated testing system to generate a testing pipeline to be used as the testing sequence. In some embodiments, the assessment of the health of the second containerized application includes at least one of: checking whether the application is up and running, checking whether the application is ready to accept traffic, checking node scheduling of the application, checking how many copies of the application should be scheduled, checking a container image size of the application, or checking node failover information associated with the application.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A system for lifecycle management testing of containerized applications, the system comprising:
a memory that stores instructions; and
at least one processor configured by the instructions to perform operations comprising:
executing a test script by a first containerized application thereby causing an Application Programming Interface (API) call to be issued to at least one automated testing system;
running, by the at least one automated testing system, a testing sequence on a second containerized application, different from the first containerized application, based on the API call; and
automatically displaying testing sequence results, wherein the results comprise an assessment of the health of the second containerized application.

2. The system of claim 1, wherein the first containerized application runs in a separate container from the first containerized application.

3. The system of claim 1, wherein the operations further comprise:
running, by a second automated testing system, a second test sequence on the second containerized application, using the testing sequence results as an input parameter.

4. The system of claim 3, wherein the operations further comprise:
running, by a third automated testing system, a third test sequence on the second containerized application, using the testing sequence results as an input parameter.

5. The system of claim 1, wherein the first and second containerized applications are in different pods on a same cluster of a network.

6. The system of claim 1, wherein the operations further comprise:
executing a second testing script, wherein
the execution of the testing script causes the at least one automated testing system to generate a testing pipeline to be used as the testing sequence.

7. The system of claim 1, wherein
the assessment of the health of the second containerized application comprises at least one of: checking whether the application is up and running, checking whether the application is ready to accept traffic, checking node scheduling of the application, checking how many copies of the application should be scheduled, checking a container image size of the application, or checking node failover information associated with the application.

8. A computer-implemented method for lifecycle management testing of containerized applications, the method comprising:
executing a test script by a first containerized application thereby causing an Application Programming Interface (API) call to be issued to at least one automated testing system;
running, by the at least one automated testing system, a testing sequence on a second containerized application, different from the first containerized application, based on the API call; and
automatically displaying testing sequence results, wherein the results comprise an assessment of the health of the second containerized application.

9. The method of claim 8, wherein
the first containerized application exists in a separate container from the first containerized application.

10. The method of claim 8, further comprising:
running, by a second automated testing system, a second test sequence on the second containerized application, using the testing sequence results as an input parameter.

11. The method of claim 10, further comprising:
running, by a third automated testing system, a third test sequence on the second containerized application, using the testing sequence results as an input parameter.

12. The method of claim 8, wherein the first and second containerized applications are in different pods on a same cluster of a network.

13. The method of claim 8, further comprising:
executing a second testing script, wherein the execution of the testing script causes the at least one automated testing system to generate a testing pipeline to be used as the testing sequence.

14. The method of claim 8, wherein
the assessment of the health of the second containerized application comprises at least one of: checking whether the application is up and running, checking whether the application is ready to accept traffic, checking node scheduling of the application, checking how many copies of the application should be scheduled, checking a container image size of the application, or checking node failover information associated with the application.

15. A non-transitory computer-readable medium for lifecycle management testing of containerized applications, storing instructions that, when executed by at least one processor, cause the at least one processor to perform operations comprising:
executing a test script by a first containerized application thereby causing an Application Programming Interface (API) call to be issued to at least one automated testing system;
running, by the at least one automated testing system, a testing sequence on a second containerized application, different from the first containerized application, based on the API call; and
automatically displaying testing sequence results, wherein the results comprise an assessment of the health of the second containerized application.

16. The medium of claim 15, wherein
the first containerized application exists in a separate container from the first containerized application.

17. The medium of claim 15, further comprising
running, by a second automated testing system, a second test sequence on the second containerized application, using data output by the first test sequence.

18. The medium of claim 16, wherein the first and second containerized applications are in different pods on a same cluster of a network.

19. The medium of claim 15, further comprising:
executing a second testing script, wherein
the execution of the testing script causes the at least one automated testing system to generate a testing pipeline to be used as the testing sequence.

20. The medium of claim 15, wherein
the assessment of the health of the second containerized application comprises at least one of: checking whether the application is up and running, checking whether the application is ready to accept traffic, checking node scheduling of the application, checking how many copies of the application should be scheduled, checking a container image size of the application, or checking node failover information associated with the application.
